(19) United States
(12) Patent Application Publication
(10) Pub. No.: US 2026/0205333 A1
(43) Pub. Date: Jul. 16, 2026

(54) AGGREGATING MULTIPLE PHYSICAL LAYER SERVICE DATA UNITS (PSDU)

(71) Applicant: Sony Group Corporation, Tokyo (JP)

(72) Inventors: Daniel VERENZUELA, Stuttgart (DE); Thomas HANDTE, Stuttgart (DE); Pukar SHAKYA, Stuttgart (DE); Ken TANAKA, Stuttgart (DE)

(73) Assignee: Sony Group Corporation, Tokyo (JP)

(21) Appl. No.: 19/134,222

(22) PCT Filed: Nov. 28, 2023
(86) PCT No.: PCT/EP2023/083309

§ 371 Date: May 30, 2025

(30) Foreign Application Priority Data
Dec. 8, 2022 (EP) 22212284.8

(51) Int. Cl. H04L 27/26

(52) U.S. Cl. CPC H04L 27/2602

(57) ABSTRACT

There is provided a transmission device comprising circuitry configured to generate a physical layer (PHY) service data unit (PSDU) including at least two PSDU parts; generate a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and transmit said PPDU to at least two receiving devices. Further provided are a corresponding receiving device and corresponding methods.

### BACKGROUND

### Field of the Disclosure

The present disclosure relates to a transmission device, a receiving device, a transmission method and a receiving method.

### Description of Related Art

Growing latency sensitive applications like extended reality (XR) gaming, remote surgery and smart manufacturing require the delivery of data units (also called latency sensitive data units or preemptive data units) within a few milliseconds or less and/or the delivery of data units with high reliability (also called high-reliability data units). Such latency sensitive data units and high-reliability data units are commonly referred to as high priority data units herein.

In conventional WLAN operation, Medium Access Control (MAC) Protocol Data Units (MPDUs) are included by a transmission device (e.g. a transmitter station (STA) or an access point (AP)) in an aggregated MPDU (A-MPDU). All MPDUs within an A-MPDU are modulated according to the same modulation operation. On a Physical (PHY) layer the A-MPDUs are embedded into PHY protocol data unit (PPDUs), which are then transmitted from the transmission device to the receiving device.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to provide for more flexibility regarding the transmission of high priority data units that enables a faster and/or more reliable delivery of such high priority data units. It is a further object to provide corresponding devices and methods as well as a corresponding computer program and a non-transitory computer-readable recording medium that stores therein a computer program product for implementing said methods.

According to an aspect there is provided a transmission device comprising circuitry configured to
generate a physical layer (PHY) service data unit (PSDU) including at least two PSDU parts;
generate a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and
transmit said PPDU to at least two receiving devices.

According to a further aspect there is provided a receiving device comprising circuitry configured to
receive a physical layer (PHY) protocol data unit (PPDU) carrying a PSDU including at least a first PSDU part and a second PSDU part, wherein the first PSDU part has been modulated by a PHY operation that is different to the PHY operation used to modulate the second PSDU part;
determine if at least one PSDU part includes data addressed to the receiving device; and
either demodulate said at least one PSDU part or skip demodulation of said at least one PSDU part if it does not include data addressed to the receiving device or the receiving device is unable to perform demodulation according to the corresponding PHY operation that has been used for modulating said at least one PSDU part.

According to still further aspects corresponding methods, a computer program comprising program means for causing a computer to carry out the steps of the method disclosed herein, when said computer program is carried out on a computer, as well as a nontransitory computer-readable recording medium that stores therein a computer program product, which, when executed by a processor, causes the method disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is provide mechanisms to support different modulation operations (herein also referred to as “PHY changes” or “PHY operations” or change of “PHY parameters”) for different MPDUs in an A-MPDU to enable that a high priority MPDU is modulated differently than other MPDUs aggregated into the same A-MPDU and carried in the same PPDU. The different modulation operations are preferably performed on an OFDM symbol basis and do preferably not involve modifications to the channel coding operation. A high priority MPDU can thus be modulated such that it has higher reliability and/or lower latency than the other MPDU within the same A-MPDU.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows diagrams comparing a multi-station A-MPDU a conventionally used with a multi-station A-MPDU as used according to an embodiment of the present disclosure.

FIG. 2 shows diagrams comparing an A-MPDU a conventionally used with an A-MPDU as used according to another embodiment of the present disclosure.

FIG. 3 shows a schematic diagram of an embodiment of a transmission device according to an embodiment of the present disclosure.

FIG. 4 shows a diagram illustrating the general relationship between data units on the MAC layer and the PHY layer.

FIG. 5 shows a schematic diagram of a first embodiment of PHY operation changes according to the present disclosure.

FIG. 6 shows a flow chart of the transmitter STA operation according to the first embodiment.

FIG. 7 shows a flow chart of the non-PHY-adapting receiver STA operation according to the first embodiment.

FIG. 8 shows a flow chart of the PHY-adapting receiver STA operation according to the first embodiment.

FIG. 9 shows a schematic diagram of a second embodiment of PHY operation changes according to the present disclosure.

FIG. 10 shows a schematic diagram of a third embodiment of PHY operation changes according to the present disclosure.

FIG. 11 shows a schematic diagram of an A-MPDU and a PPDU of an original transmission.

FIG. 12 shows a schematic diagram of a fourth embodiment of PHY operation changes according to the present disclosure.

FIG. 13 shows a flow chart of the transmitter STA operation according to the fourth embodiment.

FIG. 14 shows a schematic diagram of a fifth embodiment of PHY operation changes according to the present disclosure.

FIG. 15 shows a flow chart of the non-PHY-adapting receiver STA operation according to the fourth embodiment.

FIG. 16 shows a flow chart of the PHY-adapting receiver STA operation according to the fourth embodiment.

FIG. 17 shows a schematic diagram of another A-MPDU and another PPDU of an original transmission.

FIG. 18 shows a schematic diagram of a sixth embodiment of PHY operation changes according to the present disclosure.

FIG. 19 shows a schematic diagram of a seventh embodiment of PHY operation changes according to the present disclosure.

FIG. 20 shows a flow chart of another embodiment of a transmission method according to the present disclosure.

FIG. 21 shows a flow chart of another embodiment of a receiving method according to the present disclosure.

### DETAILED DESCRIPTION OF THE EMBODIMENTS

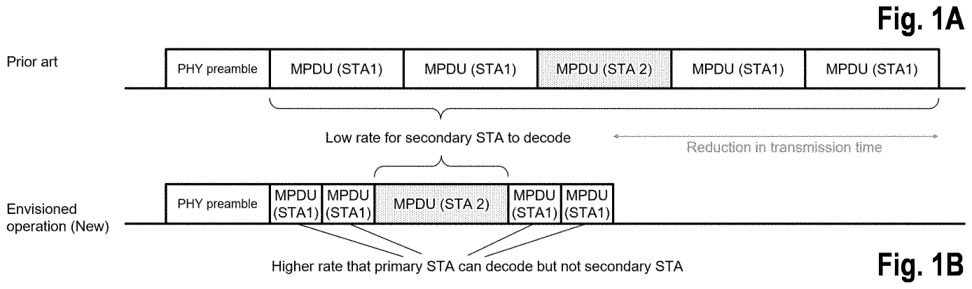

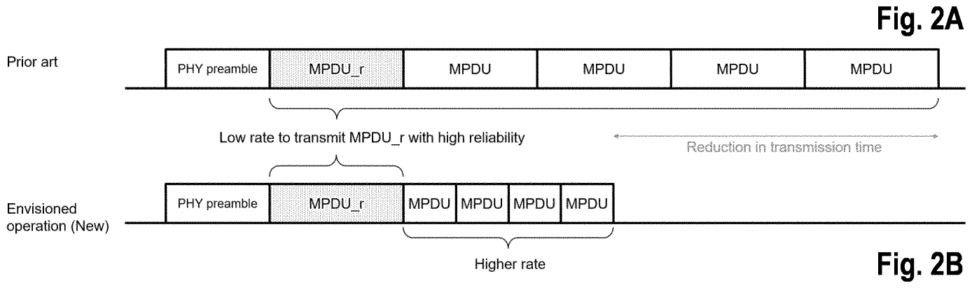

Referring now to the drawings, wherein like reference numerals designate identical or corresponding parts throughout the several views, FIGS. 1 and 2 show diagrams comparing an A-MPDU conventionally used with an A-MPDU as used according to the present disclosure for two embodiments. These figures illustrate how the present disclosure can reduce the transmission time, which is particularly of interest for low latency and reliable communications that are fundamental to support growing applications like virtual reality (VR), smart manufacturing, and remote surgery.

The use of multi-STA A-MPDUs, as shown in FIG. 1, reduces the latency of transmitting MPDUs that are addressed to different receiver STAs. For a multi-STA A-MPDU transmission, the PHY configuration is selected such that all STAs can decode the MPDUs successfully, and it is fixed for the entire multi-STA A-MPDU transmission. This is illustrated in FIG. 1A, where the same low PHY date rate is used for all MPDUs.

In general, for an A-MPDU transmission, the PHY configuration is fixed. Thus, in cases where, for example, management frames are added and need to be transmitted with high reliability, the whole A-MPDU transmission would have a low PHY data rate. This is illustrated in FIG. 2A.

Fixing the PHY data rate for an A-MPDU can result in inefficient transmissions that occupy the channel for much longer than necessary. A possible solution to this problem is illustrated FIG. 1B showing a Multi-STA A-MPDU according to an embodiment of the present disclosure, according to which STA 1 can support a high PHY data rate and STA 2 can support a low PHY data rate (e.g., due to poor link quality). Another possible solution to this problem is illustrated FIG. 2B showing an A-MPDU according to another embodiment of the present disclosure, according to which the MPDU_r (e.g. an important management frame) requires a low PHY data rate whereas the rest of the A-MPDU, i.e. the other MPDUs, can be sent with a higher PHY data rate.

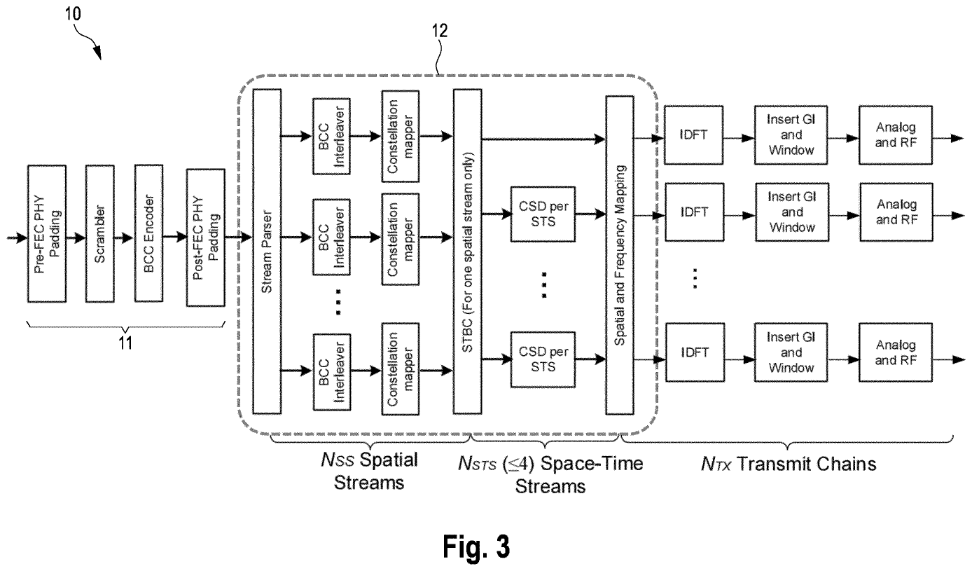

FIG. 3 shows a schematic diagram of an embodiment of a transmission device 10 according to an embodiment of the present disclosure. In the present disclosure it will be differentiated between the code rate and the PHY data rate. The code rate is the rate between payload bits before and after channel encoding which involves FEC padding, and scrambling performed in corresponding units of block 11 (on the left-hand side of block 12). Changes to the code rate for a portion of a PPDU are complex and may require large signaling.

The PHY data rate (sometimes also called “PHY rate”) herein relates to changing PHY parameters and/or PHY operation that do not change the code rate, for example the operation of the constellation mapper and the frequency (or tone) mapping (elements in block 12) which can change the modulation order, the use of dual carrier modulation (DCM), and the use of space-time block coding (STBC). The processing elements or units of the transmission device 10 that may be involved in changing the PHY data rate are indicated as block 12.

In this context, “PHY configuration” shall be understood as operations and parameters that are relevant to the PHY changes in this disclosure. This may include one or more of the following:
the enabling or disabling of OFDM replication operation wherein each OFDM symbol in a set of OFDM symbols is replicated by a set OFDM replication rate to provide more reliability;
the selection of said OFDM replication rate when OFDM replication operation is enabled;
the selection of modulation order and modulation type used by the constellation mapper to map encoded bits into complex symbols (e.g., BPSK, QPSK, 16-QAM, etc.);
the selection of a tone mapping operation to map said complex symbols into subcarriers of OFDM symbols;
the selection of a tone mapping distance and/or cyclic shift used in the tone mapping operation;
the enabling or disabling of space-time block coding and/or dual-carrier modulation to add more robustness to the transmitted OFDM symbols; and
the selection of the guard interval duration of each OFDM symbol to mitigate the effect of the delay spread.

PHY parameters shall be understood as the parameters used to configure the PHY according to a desired PHY configuration. PHY operation shall be understood as the steps and functions (i.e. the implementation of the PHY configuration) that utilize said PHY parameters to modulate the encoded bits onto OFDM symbols in a PPDU and transmit said PPDU. Mode of PHY operation shall be understood as the specific PHY configuration chosen for a specific PPDU transmission.

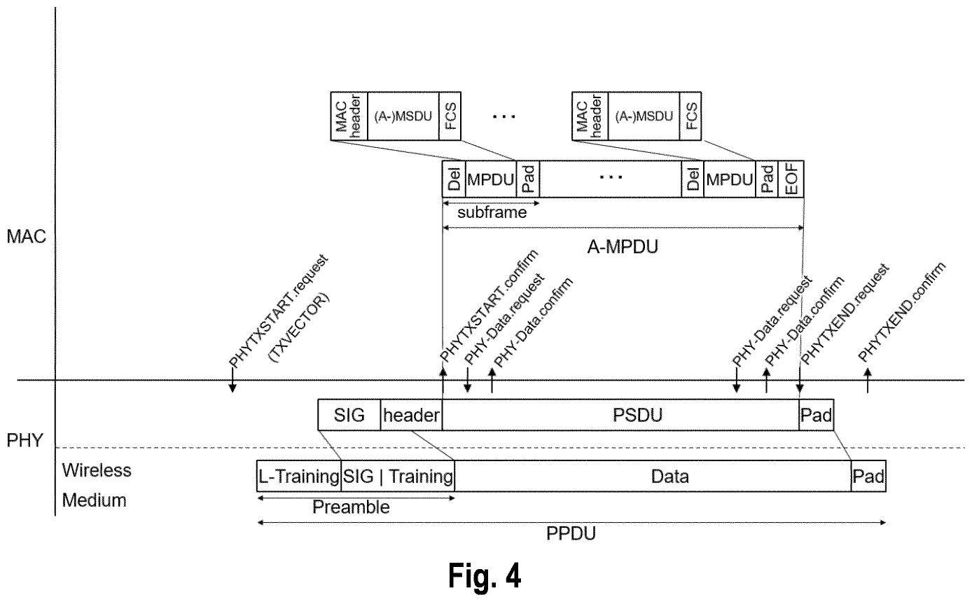

This present disclosure proposes changes mainly to the PHY operation to change the PHY data rate of selected MPDU subframes within an A-MPDU, i.e., within a PPDU, while maintaining the channel coding operation unchanged, i.e., the same code rate is generally used. The comparisons between known operation and envisioned operation in FIGS. 1 and 2 show how the PPDU duration can be reduced by the envisioned operation. A PPDU is formed of a plurality (i.e. two or more) of OFDM symbols transmitted by the PHY layer that are a function of the MPDUs from the MAC layer as e.g. shown in FIG. 4. FIGS. 1 and 2 are illustrating the benefits of the present disclosure, but shall not be understood such that MPDUs are directly transmitted. The actual transmission procedure will be explained below.

To support the PHY data rate changes the transmitter and receiver STAs may exchange capabilities and modes of operation supported in a session setup. In this information exchange, two types of receiver STA operations are defined: the non-PHY-adapting receiver STA (e.g. a legacy STA) and the PHY-adapting receiver STA (e.g. a STA according to the present disclosure). The difference between these receiver STAs is that the PHY-adapting receiver STA is the intended receiver of a MPDU subframe that contains PHY data rate changes.

The information exchange in the session setup may contain one or more of the following elements:
a session type identifier, which can be used to indicate a set of parameters to use and/or a mode of operation;
the type of indication, e.g. a signaling type identifier, to identify the A-MPDU that contains PHY data rate changes (it may be carried in a PHY preamble or in additional training and signaling OFDM symbols);
a mode identifier to identify modes of PHY data rate change operation, which may e.g. be OFDM symbol replication and/or OFDM symbol adaptation.

The session type identifier thus indicates a session where several PHY operation changes can be used. The mode identifier indicates specific PHY operation (out of the ones agreed in the session) that shall be applied to a specific group of one or more PPDUs. OFDM replication is a new separate operation, but OFDM symbol adaptation is the result of changing the other parameters and modes of operation. As a result, OFDM symbols needed can increase or decrease compared to the original number, which is a consequence of the changes. The receiver STAs signal their capabilities to the transmitter STA, which then uses what is supported by the receiver STAs. What the transmitter STA then uses may be specified in the preamble of a PPDU.

To implement the PHY data rate changes two main cases of the operation may be distinguished. According to a first case (Case 1) the transmitter STA knows that a MPDU subframe will be transmitted with PHY data rate changes before the PHYTXSTART.request is issued. According to a second case (Case 2) the transmitter STA wants to insert a MPDU subframe with PHY data rate changes after the PHYTXSTART.request is issued. Further, two main modes of operation to change the PHY data rates may be distinguished. According to a first mode (Mode 1) OFDM symbol replication may be applied, according to which the OFDM symbols carrying data from a specific A-MPDU subframe are replicated by a specified amount to add reliability. According to a second mode (Mode 2) OFDM symbol adaptation may be applied, according to which the OFDM symbols carrying data from a specific A-MPDU subframe contain PHY data rate changes. In the following the operation of the transmitter STA, a non-PHY-adapting receiver STA and a PHY-adapting receiver STA for each of the respective cases and modes of operation will be described.

Before the various cases and modes will be explained in detail by use of various figures and embodiments, the general relationship between data units on the MAC layer and the PHY layer will be explained by reference to FIG. 4. FIG. 4 illustrates particularly the relationship between MSDUs, MPDUs, A-MPDU, PSDU and PPDU.

The MPDUs contain one or more MAC service data units (MSDUs). The MSDUs arrive from higher layers and are placed in different queues at the MAC layer depending on their priority. Enhanced distributed channel access functions (EDCAFs) coordinate the channel access for transmitting MSDUs from the queues. A single MSDU can be transmitted at a time or multiple MSDUs can be aggregated to form an Aggregated MSDU (A-MSDU). To transmit the MSDUs as shown in FIG. 4, the MAC layer creates MPDUs by taking the MSDUs and adding a MAC header and a frame check sequence (FCS). The MAC header contains signaling information that includes transmitter address and receiver address (RA), duration, frame control, etc., and the FCS corresponds to a sequence used to validate if the MPDU is received correctly at the receiver.

An A-MPDU includes a concatenation of MPDUs which are encapsulated in subframes, each subframe having a delimiter (DEL) and an optional padding (PAD) field. The DEL contains the length of the MPDU in a subframe and a signature to help identify each subframe at the receiver while the PAD is used to make sure the length of each subframe is a multiple of a predetermined number (e.g. 32) of bits.

At the time the PHYTXSTART.request indication is sent, the total data length (e.g. in octets) of the A-MPDU is indicated via the TXVECTOR. The A-MPDU is carried by a PHY layer as a PHY service data unit (PSDU). The PSDU is processed by the PHY including encoding and modulation, resulting in OFDM symbols transmitted into the wireless medium as part of a PHY protocol data unit (PPDU). The PPDU contains a preamble, including training and signaling fields, and a data field where the PSDU is carried.

Once the PHYTXSTART.request is received by the PHY, the process to transmit a PPDU starts with the PHY preamble. The PHY sends a PHYTXSTART.confirm indication to the MAC to indicate that it is ready to receive data. Afterwards the MAC issues a PHYData.request indication to transfer (e.g. an octet of) data to the PHY, which in turn transmits the data (e.g. the octet). Once the PHY receives the data (e.g. octet) it issues an PHY-Data.confirm to indicate to the MAC that it is ready to receive other data (e.g. another octet). This process is done continuously until the last data (e.g. the last octet) of the PSDU is sent. Finally, the MAC issues a PHYTXEND.request to indicate to the PHY that the PSDU transmission is completed, and in turn the PHY finishes the PPDU transmission and issues an PHYTXEND.confirm to the MAC.

Briefly summarized, PSDU parts are encoded, modulated as complex symbols, mapped to subcarriers of OFDM symbols, and finally the OFDM symbols are the ones transmitted. The PHY operation includes the process of taking the PSDU and transmitting it as OFDM symbols. The PSDU parts are the ones modulated onto OFDM symbols.

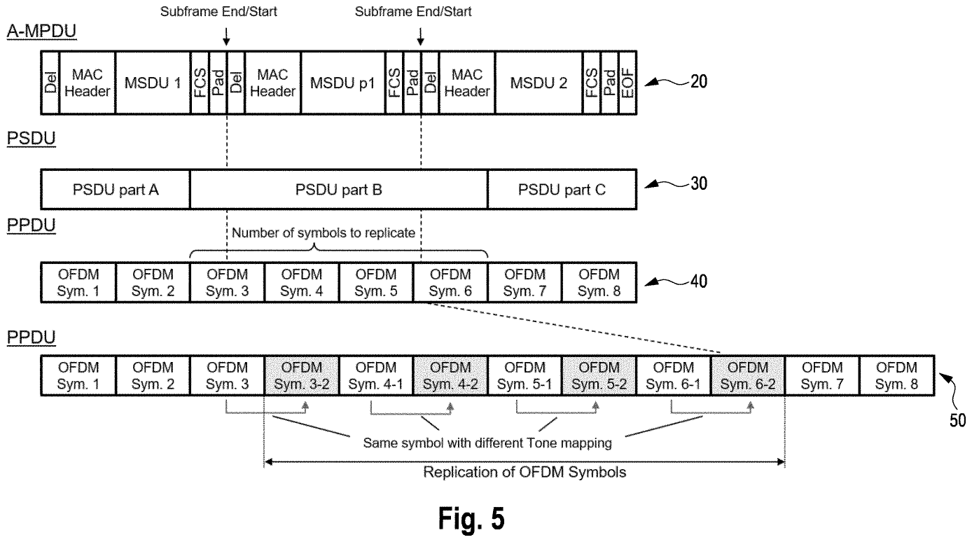

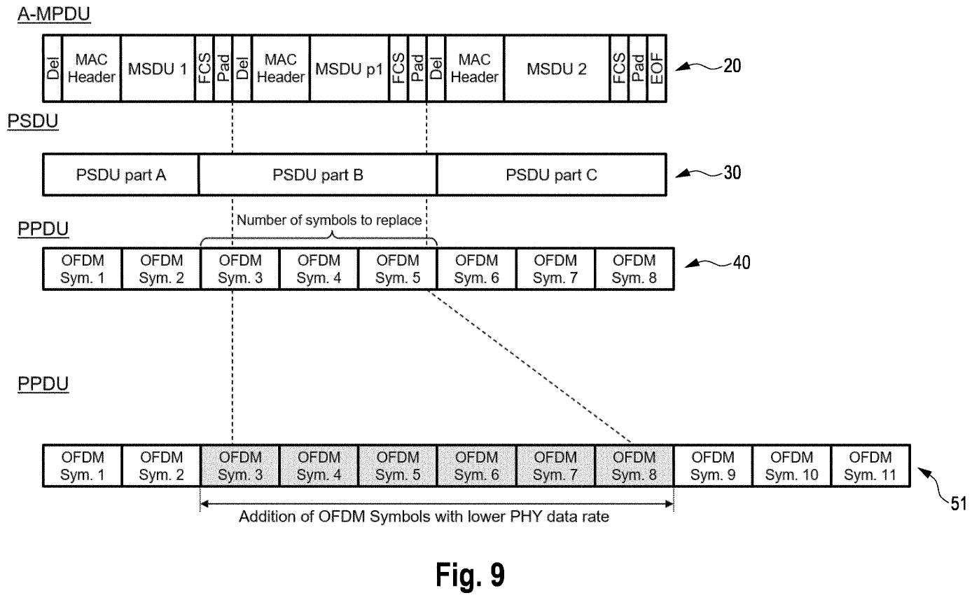

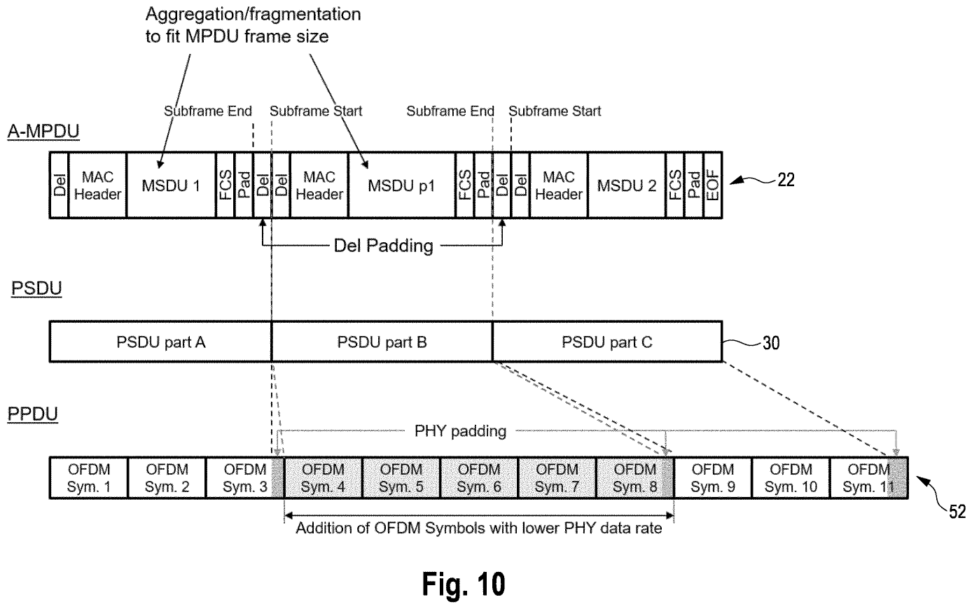

According to the present disclosure, the PSDU can be divided into several parts, wherein each part can be processed differently by the PHY layer resulting in different number of OFDM symbols depending on the applied PHY operation (e.g. by use of one or more different PHY parameters or PHY configurations). Each PSDU part can be selected to overlap (or correspond) with specific MPDUs of an A-MPDU so that each MPDU can be transmitted with different PHY operation. A PSDU part with PHY changes can overlap entirely with an integer number of MPDUs (i.e. correspond to said integer number of MPDUs; see also FIG. 10 below) or it can overlap partially with several MPDUs (see also FIGS. 5 and 9 below). One of the benefits of having the PSDU part with PHY changes overlapping with at least an entire MPDU addressed to a different receiver STA is to provide a different reliability or latency performance.

FIG. 5 shows a schematic diagram of a first embodiment of PHY operation changes according to the present disclosure. It illustrates Case 1 and Mode 1, according to which PHY data rate changes are known in advance and OFDM symbol replication is applied, in this exemplary embodiment for a replication factor (herein also called OFDM replication rate) of 2. FIG. 5 shows an A-MPDU 20, a PSDU 30, a conventional PPDU 40 and a PPDU 50 according to the present disclosure.

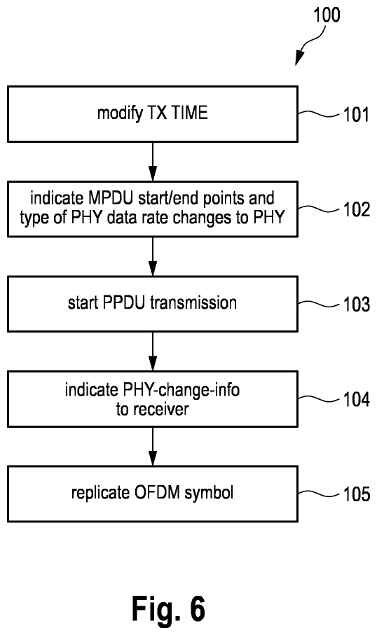

FIG. 6 shows a flow chart of the transmitter STA operation 100 according to this embodiment. If PHY data rate changes are to be included in an upcoming PPDU, the transmitter in step 101 modifies the PPDU length information (e.g., TXTIME) to account for the repeated OFDM symbols before the MAC circuitry issues the PHYTXSTART.request. In this case the TXTIME can be modified as follows

$${TXTIME}_{P H Y - c h a n g e} = {TXTIME}_{non - PHY - change} + {N}_{rep} \cdot ( {f}_{rep} - 1 ) \cdot {T}_{s y m}$$

where TXTIME_{non-PHY-change} is the TXTIME of the PPDU before considering any PHY data rate changes which is computed as in the WLAN standard specification. The number of OFDM symbols to replicate is given by Nᵣₑₚ (e.g., 4 in FIG. 5, as shown in the PPDU 50 corresponding to the PSDU part B of the PSDU 30) and fᵣₑₚ is the replication factor (e.g., 2 in FIG. 5), and T_{sym} is the time duration of an OFDM symbol including guard interval or cyclic prefix.

In step 102 the MAC circuitry indicates to the PHY circuitry the following items. This can be done as part of the TXVECTOR or as separate indications:
i) The MPDU subframe start and/or end points around the MPDU subframe that requires PHY data rate changes. This can be done by indicating the last octet of the MPDU subframe preceding and/or containing the PHY data rate changes and/or by indicating the first octet of the DEL at the beginning and/or after the subframe with PHY data rate changes.
ii) The type of PHY data rate changes that shall be done, in this case OFDM symbol replication, and related parameters: replication factor and tone mapping operation for replicated OFDM symbols.

In step 103 the PHY circuitry starts PPDU transmission after receiving PHYTXSTART.request containing the modified PPDU duration and PHY data rate mode of operation.

In step 104 the transmitter STA indicates information for the receiver STAs to identify the PHY data rate changes in the PHY preamble, herein called PHY-change-info or signaling of PHY operation changes. Each information item can be added explicitly, or a pre-agreed set of parameters can be used, indicated with a session identifier. The information contains one or more of the following:
AID of the PHY-adapting receiver STA and/or RU allocation for the A-MPDU with PHY data rate changes;
The replication factor (i.e., number of times each OFDM symbol is repeated, e.g., 2 in FIG. 5);
OFDM symbol start/end indices; and
Alternative tone mapping operation (symbol interleaver) for replicated OFDM symbols.

To find the OFDM symbol start/end indices the MAC circuitry can divide the length of the MPDU subframes between the number of data bits per symbol (NDBPS) and see how many OFDM symbols are needed per MPDU subframe. Alternatively, the MAC circuitry can exchange signaling with the PHY circuitry before the PPDU start to obtain this information. The OFDM symbol index where the replication starts can be the OFDM immediately preceding the replication (OFDM symbol 3 in FIG. 5) and/or the first replicated OFDM symbol (OFDM symbol 3-2 in FIG. 5). The OFDM symbol index where the replication ends can be done by one of the following: The last OFDM symbol that is replicated (OFDM symbol 6-2 in FIG. 5), the OFDM immediately after the replication (OFDM symbol 7 in FIG. 5), and/or a fixed number of OFDM symbols after the OFDM symbol index pointing to the start of the replication operation.

While in the conventional PPDU 40 no OFDM symbols are replicated, in step 105 the PHY circuitry replicates OFDM symbols of the PSDU part B starting at the symbol where the MPDU subframe addressed to the PHY-adapting receiver STA starts. Optionally, an alternative tone mapping operation that is different from the original OFDM symbol and different among replicated OFDM symbols may additionally be performed. The alternative tone mapping operations can be achieved by changing a tone spacing parameter (D_{TM}) and/or by a fixed cyclic shift with respect to the previous tone mapping. If the non-PHY-adapting receiver STA is a legacy STA, no MPDU subframes addressed to this STA can be added after the PHY data rate changes. The other PSDU parts A and C are not replicated as shown for the PPDU 50.

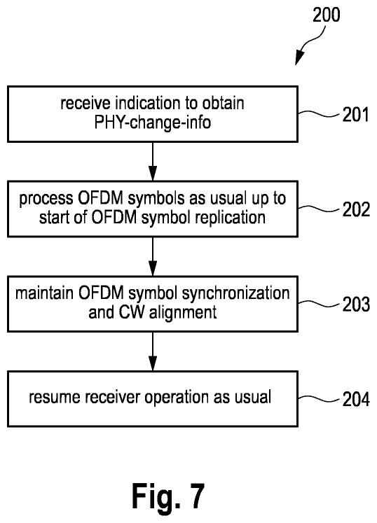

FIG. 7 shows a flow chart of the Non-PHY-adapting receiver STA operation 200 according to this embodiment. In a first step 201 an indication in the PHY preamble to obtain PHY-change-info is received. In a second step 202 OFDM symbols in the data field are processed as usual until the last OFDM symbol before the OFDM symbol replication starts (e.g., symbol 3 in FIG. 5). In step 203 OFDM symbol synchronization and codeword (CW) alignment are maintained to resume reception of subframes after PHY changes. This can be done by selecting, within the symbol replication, only the first OFDM symbol from each replicated group (e.g., symbol 4-1, symbol 5-1, and symbol 6-1 in FIG. 5) and/or by processing CWs as usual or keep tract of CW end/start after constellation de-mapping. To save energy the receiver can also choose not to decode CWs in OFDM symbols inside the replication (e.g., CWs in symbol 4-2 and sym5-2 in FIG. 5). After all replicated symbols have passed, the STA can resume receiver operation as usual in step 204. If the STA is a legacy STA, it processes the A-MPDU as usual and would only be able to decode the first MPDU subframes before the OFDM symbol replication.

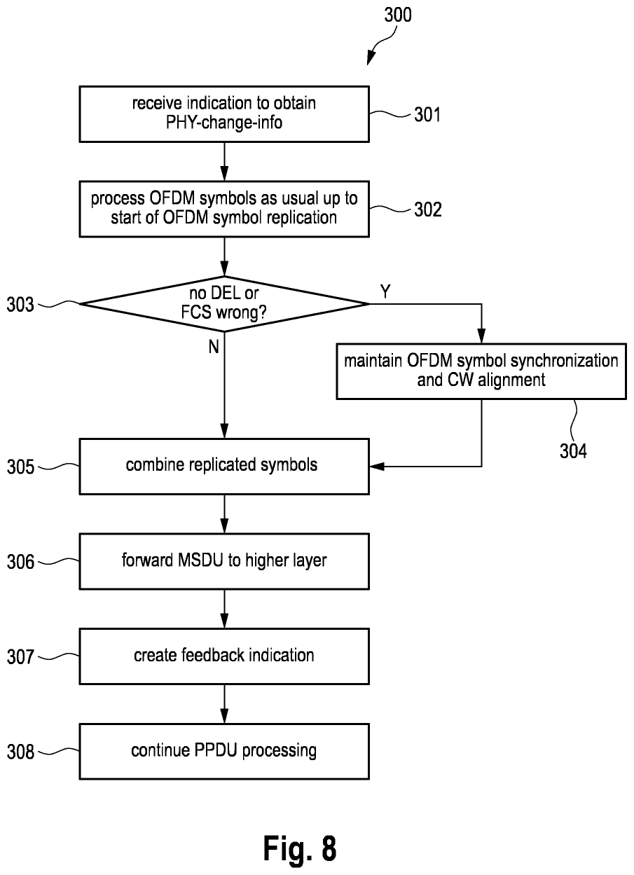

FIG. 8 shows a flow chart of the PHY-adapting receiver STA operation 300 according to this embodiment. In a first step 301, an indication in the PHY preamble to obtain PHY-change-info is received. In a second step 302, OFDM symbols in data field are processed as usual until the last OFDM symbol before the OFDM symbol replication starts (e.g., symbol 3 in FIG. 5). If no DEL is identified or the FCS is wrong, as checked in step 303, processing the OFDM symbols is continued in step 304 to maintain the synchronization and CW alignment. Within the symbol replication, in step 305 the STA combines the replicated symbols by, for example, adding the LLR values extracted from data symbols in data subcarriers in each replicated OFDM symbol after tone de-mapping operation. Once all replications of a given symbol are combined, the decoding process is continued.

If a DEL is found in step 303, the FCS check is correct, and the receiver address in the MAC header corresponds to the PHY-adapting receiver STA, then the MSDU is forwarded to higher layers in step 306. The STA can create a feedback indication in step 307 and send it in a separate frame to indicate to the transmitter STA that the PHY data rate changes were successful or not.

After all replicated symbols have passed, the STA can continue processing the PPDU in step 308 if more PHY data rate changes have been indicated, otherwise it can stop decoding to save energy and set the NAV accordingly. In case several separate PHY changes are included into a PPDU transmission it is possible to use one of the following mechanisms to reduce the signaling overhead: Subframes with equal PHY changes can be grouped and transmitted consecutively such that the start and end OFDM symbol information is conveyed once for the entire group. Further, at least part of the PHY-change-info can be moved to a MAC signaling field at the start of the A-MPDU.

FIG. 9 shows a schematic diagram of a second embodiment of PHY operation changes according to the present disclosure. It illustrates Case 1 and Mode 2, according to which PHY data rate changes are known in advance and OFDM symbol adaptation is applied. According to this exemplary embodiment, three additional OFDM symbols are added as shown for PPDU 51 compared to the conventional PPDU 40 to increase the reliability of the MPDU subframe and the PSDU part B addressed to the PHY-adapting receiver STA. The PHY data rate changes may be done for an integer number of OFDM symbols. Thus, the PSDU part B with conventional PHY operation would be modulated onto 3 OFDM symbols (e.g., OFDM symbols 3 to 5 in PPDU 40) whereas with PHY operation changes the PSDU part B is modulated onto 6 OFDM symbols (e.g., OFDM symbols 3 to 8 in PPDU 51) which can be achieved by, for example, decreasing the modulation order from 4 (16-QAM) to 2 (QPSK).

First, the transmitter operation is described. Similar to step 101 of the first embodiment explained with reference to FIG. 5, the TXTIME can be modified as follows:

$${TXTIME}_{PHY - change} = {TXTIME}_{non - PHY - c h a n g e} + {N}_{adapt} \cdot {T}_{s y m}$$

where N_{adapt} is the number of OFDM symbols that are added (or subtracted if N_{adapt} is negative) to the original transmission time. This number can be calculated as:

$${N}_{adapt} = ⌈ {N}_{rep} ( \frac{{N}_{DBPS}}{{N}_{DBPS - adapt}} - 1 ) ⌉ \qquad ( 1 )$$

where Nᵣₑₚ accounts for the number of OFDM symbols that require PHY changes (e.g., 3 in FIG. 9). The ratio

$$\frac{{N}_{DBPS}}{{N}_{DBPS - adapt}}$$

indicates if the PHY data rate changes add OFDM symbols (i.e., greater than 1) or subtract OFDM symbols (i.e., lower than 1). Hereby, N_{DBPS} is the number of data bits per OFDM symbol without PHY data rate changes and N_{DBPS-adapt} is the number of data bits per OFDM symbol with PHY data rate changes.

Because of the ceiling operation in Equation (1), it may be necessary to add PHY padding to the last OFDM symbol. FIG. 10 shows a schematic diagram of a third embodiment of PHY operation changes according to the present disclosure using aggregation, fragmentation and padding to align MPDU subframe start/end around PHY changes. In another embodiment only one or two of aggregation, fragmentation and padding may be used. The PHY padding can contain fixed pre-agreed complex symbols or a repetition of data symbols. An A-MPDU 22 including aggregation and fragmentation and a PPDU 52 including PHY padding are shown in FIG. 10.

Subsequently, similar to step 102 of the first embodiment, the MAC circuitry indicates to the PHY circuitry the following items:
i) MPDU subframe start/end around PHY data rate changes;
ii) Type of PHY data rate changes which includes one or more of the following:
   Change on modulation scheme in the constellation mapper (e.g., change from 16-QAM to QPSK); and
   to enable or disable the use of DCM and/or STBC.

Since the PHY data rate changes are per OFDM symbol, the end of the subframe preceding the PHY changes may be included in an OFDM symbol with PHY changes as shown in FIG. 9. To support legacy operation or to simplify the PHY operation at the non-PHY-adapting receiver, the transmitter can start of the subframe with PHY changes in a separate OFDM symbol. Thus, the transmitter can perform (depending on the minimum MPDU start spacing this may not be necessary) one or more of the following operations (as shown in FIG. 10):
Aggregation and/or fragmentation of MSDUs in the subframe preceding PHY changes (e.g., containing MSDU 1 in FIG. 10);
Aggregation of MSDUs in the subframe with PHY changes (e.g., containing MSDU p1 in FIG. 10);
Padding using DEL before and/or after the MPDU subframe being transmitted with PHY changes; and
PHY Padding to fill the OFDM symbol before PHY changes, ending PHY changes and/or last OFDM symbol.

Subsequently, PPDU transmission with length and PHY changes is started as in step 103. In subsequent step (like step 104) the transmitter indicates in PHY preamble PHY-change-info, including the type of PHY data rate changes and/or an OFDM symbol index where the PHY data rate changes start and/or end and/or their duration. In a subsequent step, the PHY circuitry applies PHY data rate changes to the OFDM symbol containing the start of the MPDU subframe that requires PHY changes, until the OFDM symbol containing the end of said subframe. Afterwards, the PHY operation reverts to the original operation. In case of a legacy STA behavior, no MPDU subframes addressed to this STA can be added after the PHY data rate changes.

Next, the non-PHY-adapting receiver STA operation is described for the second and third embodiments. Initially, step 201 is performed, according to which PHY-change-info is obtained. Subsequently, similar to step 202, OFDM symbols are processed up to the OFDM symbol before the one containing PHY changes (e.g., symbol 2 in FIG. 9). For the OFDM symbol containing the start of PHY changes, OFDM demodulation is performed and the frequency de-mapping and/or constellation de-mapping is modified to retrieve data symbols with PHY changes. Subsequently, similar to step 203, OFDM symbol synchronization and CW alignment are maintained. This can be done by continuing modified OFDM symbol processing up to the last OFDM symbol containing PHY changes and/or demodulating OFDM symbols and performing frequency and constellation demapping. To save energy, the device can stop decoding CWs that are mapped to PHY changes while keeping track of the transition points between CWs (i.e., when each CW starts/ends) to maintain codeword alignment.

For the last OFDM symbol preceding and/or containing PHY changes (e.g., symbol 3 or 8 in FIG. 10), PHY padding, if any, is discarded or processed. If the PHY padding contains a repetition of data symbols, the receiver can combine the LLR values from padding data symbols with their corresponding LLR values of original data symbols to increase reliability. Then, similar to step 204, after PHY changes processing OFDM symbols as usual is performed. Finally, if the STA is a legacy STA, it processes the A-MPDU as usual and would only be able to decode the first MPDU subframes before the OFDM symbols containing PHY changes.

Next, the PHY-adapting receiver STA operation is described for the second and third embodiments. Initially, step 301 is performed to obtain PHY-change-info. Afterwards, Similar to steps 302 to 304, OFDM symbols are processed up to the OFDM symbol preceding the PHY changes (e.g., symbol 2 in FIG. 9) even if decoding fails. Then, similar to step 305 the OFDM symbol containing the start of PHY changes are processed accordingly and OFDM symbol processing is continued until the last OFDM symbol containing PHY changes. Subsequently, as explained above for the non-PHY-adapting receiver STA operation, for the last OFDM symbol preceding and/or containing PHY changes, PHY padding, if any, is discarded or processed. If the PHY padding contains a repetition of data symbols, the receiver can combine the LLR values from padding data symbols with their corresponding LLR values of original data symbols to increase reliability. Subsequently, steps 306 to 308 may be performed.

The first, second and third embodiments described above illustrate different modes for Case 1, according to which PHY data rate changes are known in advance. In the following, embodiments will be described for Case 2, according to which PHY data rate changes are not known in advance.

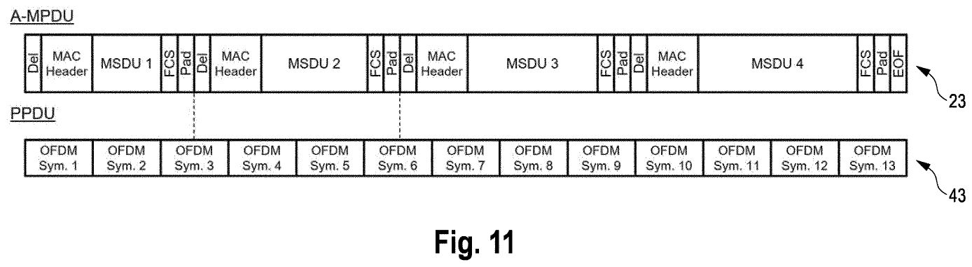

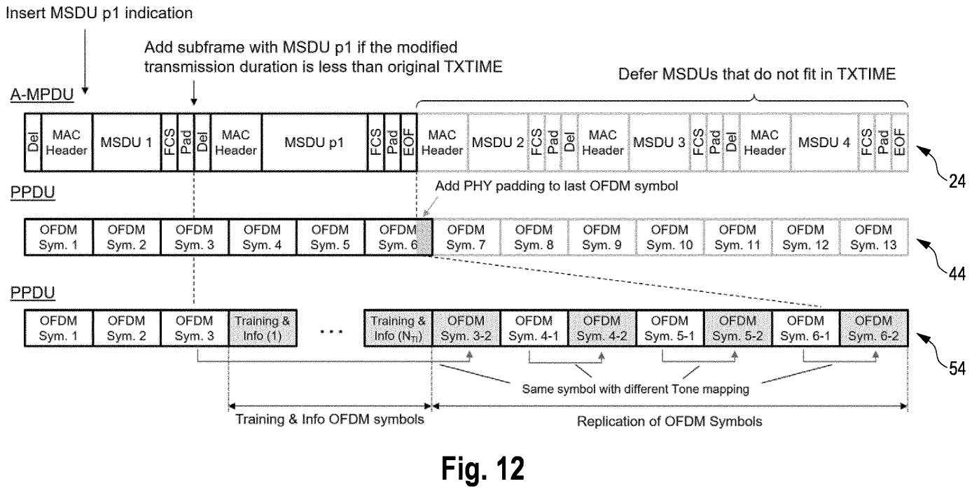

FIG. 11 shows a schematic diagram of an A-MPDU 23 and a PPDU 43 of an original transmission. FIG. 12 shows a schematic diagram of a fourth embodiment of PHY operation changes according to the present disclosure. It illustrates Case 2 and Mode 1, according to which PHY data rate changes are not known in advance and OFDM symbol replication is applied. According to this embodiment an indication to insert MSDU p1 arrives after the PHYTXSTART.request. Thus, the PPDU length has already been set and the A-MPDU content may be adapted to enable PHY data rate changes within the set PPDU length. FIG. 12 shows an A-MPDU 24, a PPDU 44 obtained by use of a PHY configuration with fixed PHY data rate and a PPDU 54 obtained by use of a PHY configuration with changing PHY data rate by OFDM symbol replication, wherein this exemplary embodiment uses a symbol replication factor of 2.

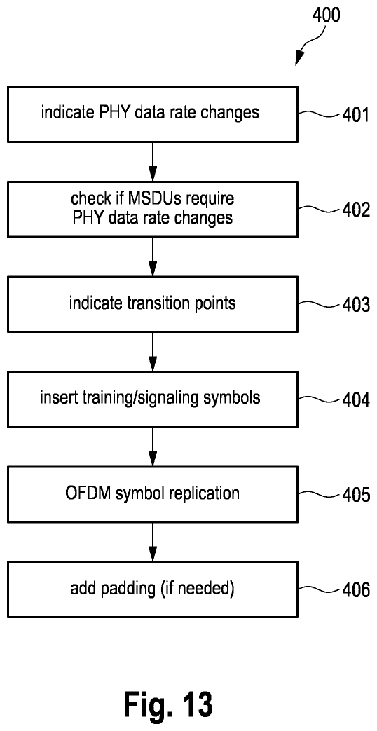

FIG. 13 shows a flow chart of the transmitter STA operation 400 according to this embodiment. In step 401 it is indicated to receiver STAs that specific PPDUs may contain PHY data rate changes. This can be indicated in the PHY preamble or in separate frames. In step 402 it is checked if the MSDUs requiring PHY data rate changes (e.g., MSDU p1 in FIG. 12) can be transmitted after the current MPDU subframe transmission without exceeding the set transmission time (e.g., TXTIME). This can be checked by the following condition:

$${TXTIME}_{n o n - PHY - change} > ( {N}_{s y m - bef - PHYchg} + ( {N}_{rep} \cdot {f}_{rep} - 1 ) + {N}_{TI} ) \cdot {T}_{sym}$$

where N_{sym-bef-PHYchg} is the number of OFDM symbols before replication (e.g. 3 in FIG. 12) and N_{TI} is the number of symbols used for training and signaling. If the above condition is met, the MSDU p1 can be transmitted, otherwise not.

In step 403 the operation corresponding to step 102 (shown in FIG. 6) is carried out according to which transition points between MPDU subframes and the type of PHY data rate changes are indicated. Then, in step 404 after the OFDM symbol preceding the PHY changes (e.g., symbol 3 in FIG. 12) training and signaling symbols are inserted to indicate to receiver STAs that an unplanned PHY data rate change is taking place (OFDM replication in this embodiment) and to indicate PHY-change-info. This can be explicitly included, identified by a session identifier or implicitly included by a specific type of training field. The type of training field can be created by using LTFs as part of midambles in the PPDU data field. To include an implicit indication in midambles the following changes can be applied: Multiply selected tones (can be all) in LTF sequences with a specific phase shift (e.g., −1) and/or modify mapping operation to invert said specific phase shift in the selected tones when transmitting the subsequent data field. As an example, if the initial shift was −1, the mapping multiplies the spatial streams with −1. Optionally, for receiver STAs training symbols may be used to improve the channel estimation quality. If the implicit indication in midambles is used and the training symbols from the preamble are to be used, the receiver may account for the phase shifts in the selected tones.

Subsequently, as step 405 the operation of step 105 is performed according to which after training and signaling symbols OFDM symbol replication is performed. If the remaining TXTIME is too short to add more subframes as shown in FIG. 12, the MAC circuitry does not insert the next subframe and/or inserts an End of Frame (EOF) indication after the subframe with PHY changes in step 405. If necessary, the PHY circuitry may add padding to the last replicated OFDM symbols in step 406.

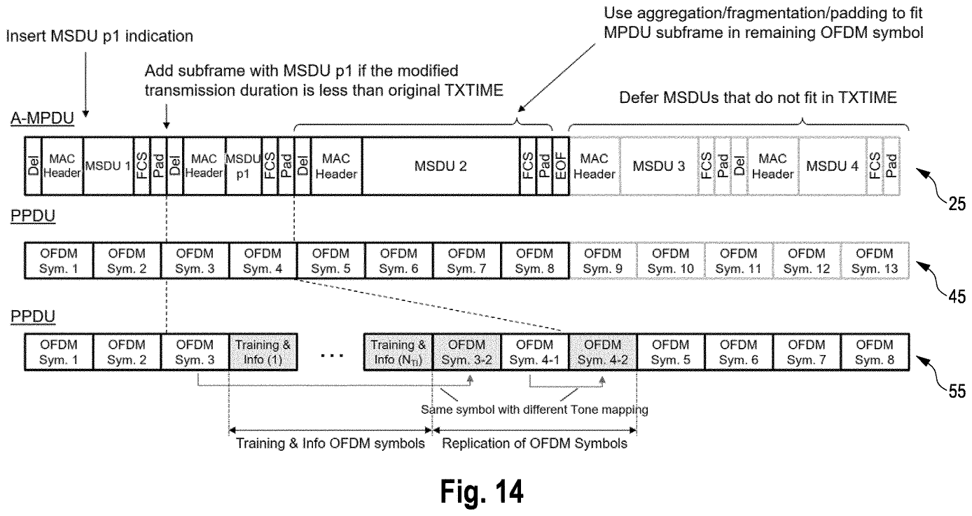

If there is enough TXTIME to add further MPDU subframes, the MAC circuitry can perform MSDU aggregation/fragmentation and/or DEL padding to fill the remaining TXTIME as best as possible. If necessary, the PHY circuitry can add PHY padding to the last OFDM symbol. This is illustrated in FIG. 14 showing a schematic diagram of a fifth embodiment of PHY operation changes according to the present disclosure. FIG. 14 shows an A-MPDU 25, a PPDU 45 obtained by use of a PHY configuration with fixed PHY data rate and a PPDU 55 obtained by use of a PHY configuration with changing PHY data rate by OFDM symbol replication, wherein further OFDM symbols are added at the end of the PPDU 55 after the OFDM symbols of the MPDU subframes using PHY changes. The inserted MPDU subframe with the PHY changes is thus not the last MPDU subframe in the PPDU 55. Finally, the above-described operation of legacy STA behavior may be performed.

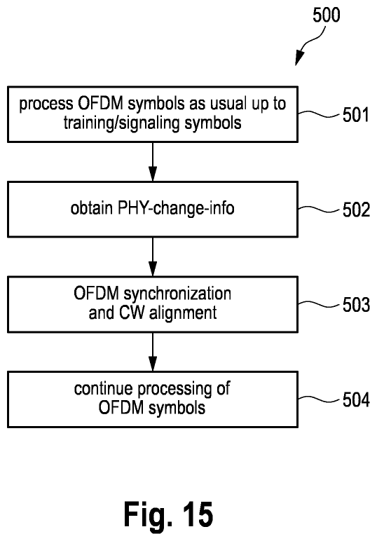

FIG. 15 shows a flow chart of the non-PHY-adapting receiver STA operation 500 according to this embodiment. In step 501 OFDM symbols in the PPDU are processed as usual until training and signaling symbols are found. In step 502 PHY-change-info is obtained based on an indication in training and signaling symbols. Training and signaling symbols can be used to improve channel estimates if enabled. In case midambles are used as implicit indication, the receiver STA calculates channel estimates based on midambles and compares them with previous channel estimates (e.g., by a per tone multiplication of new channel estimates with complex conjugate of previous ones). The indication can be extracted from specific (e.g., pre-agreed) phase shifts detected in said comparison. To continue processing the subsequent data field, the updated channel estimates may be used.

In step 503 the operation of step 203 is performed after training and signaling symbols (OFDM synchronization and CW alignment). In step 504 the operation of step 204 is performed (continue processing of OFDM symbols if any). Finally, the above-described legacy STA behavior operation may be performed.

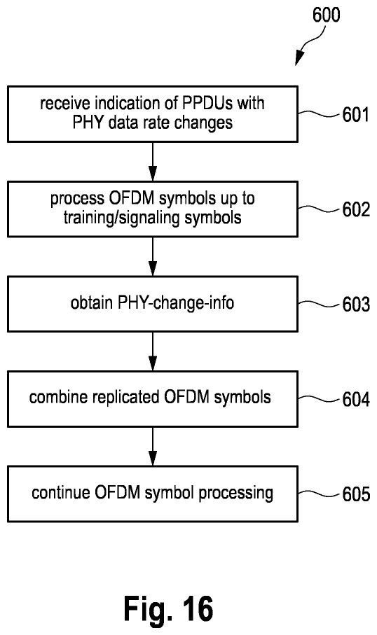

FIG. 16 shows a flow chart of the PHY-adapting receiver STA operation 600 according to this embodiment. In step 601 an indication from the transmitter STA is received to identify which specific PPDU may contain PHY data rate changes. If no such indication exists, the STA can process every PPDU as usual until it finds training and signaling symbols. In step 602 the operation of steps 302 to 304 is performed (process OFDM symbols up to training/signaling symbols). In step 603 the operation of step 502 is performed (obtain PHY-change-info). In step 604 the operation of step 305 is performed (combine replicated OFDM symbols). In step 605 the operation of steps 306 to 308 may be performed, i.e., the receiver STA forwards MSDUs to higher layers, optionally creates feedback indication and can continue processing of OFDM symbols if more PHY changes are indicated in training and signaling symbols.

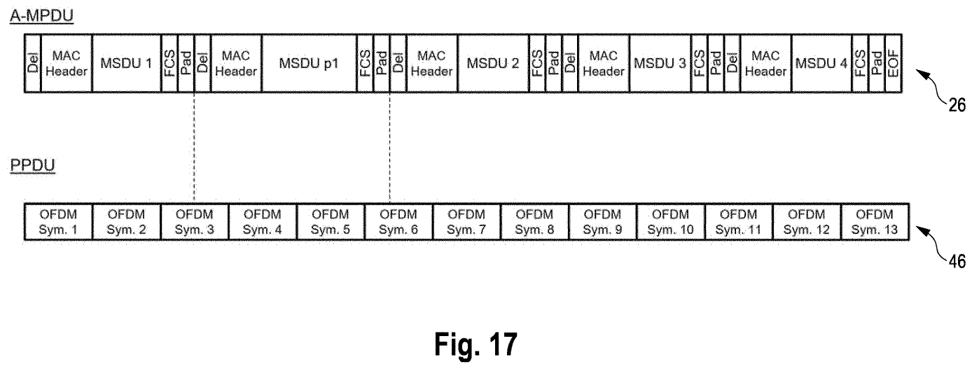

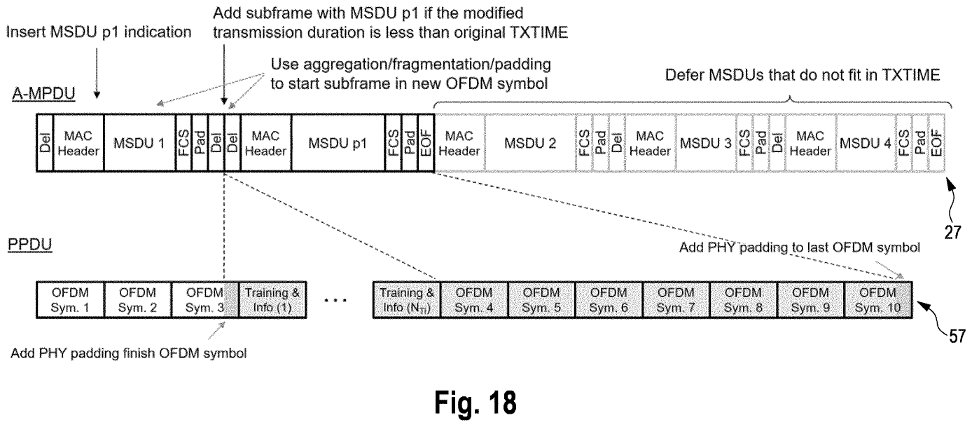

FIG. 17 shows a schematic diagram of another A-MPDU 26 and another PPDU 46 of an original transmission. FIG. 18 shows a schematic diagram of a sixth embodiment of PHY operation changes according to the present disclosure. It illustrates Case 2 and Mode 2, according to which PHY data rate changes are not known in advance and OFDM symbol adaptation is applied. FIG. 18 shows an A-MPDU 27 and a PPDU 57 obtained by use of a PHY configuration with changing PHY data rate by OFDM symbol addition. According to this embodiment additional OFDM symbols are added to increase reliability for the MPDU subframe carrying MSDU p1. The PHY data rate changes are done for an integer number of OFDM symbols.

First, the transmitter STA operation is described for the sixth embodiment. Initially, the operation of step 401 is performed (indication of PPDU with possible PHY changes). Then, similar to step 402, it is checked if the MSDU to be inserted fits within the remaining TXTIME. This can be checked by the following condition:

$${TXTIME}_{n o n - PHY - change} > ( {N}_{sym - bef - PHYchg} + {N}_{adapt} + {N}_{TI} ) \cdot {T}_{sym}$$

where N_{adapt} is given in Equation (1). PHY padding may be added to the last OFDM symbol if necessary (due to the ceiling operation in N_{adapt} calculation).

Subsequently, as explained above for Case 1 Mode 2, the MAC circuitry provides to the PHY circuitry an indication of transition between MPDU subframes and the type of PHY data rate changes and performs aggregation, fragmentation and/or padding to align the MPDU subframe with PHY changes at the start and/or end in a separate OFDM symbol. PHY padding is added, if necessary, to the OFDM symbol preceding the PHY changes (e.g., symbol 3 in FIG. 18). This ensures that the MPDU subframes with PHY changes are transmitted in the OFDM symbols after the training and signaling symbols.

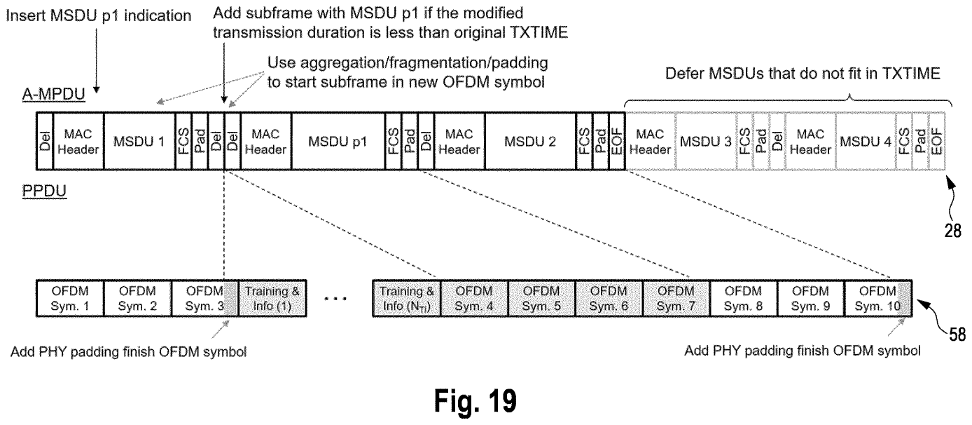

Then, the operation of step 404 is performed to insert training and signaling symbols after last OFDM symbol without PHY changes (e.g., after symbol 3 in FIG. 18). After the training and signaling symbols the PHY changes are applied. If the remaining TXTIME is too short as shown in FIG. 18, the MAC circuitry does not insert another subframe and/or inserts EOF and, if necessary, the PHY circuitry adds PHY padding to the last OFDM symbol. Otherwise, MPDU subframes are added if TXTIME allows it. This is illustrated in FIG. 19 showing a schematic diagram of a seventh embodiment of PHY operation changes according to the present disclosure. FIG. 19 shows an A-MPDU 28 and a PPDU 58 obtained by use of a PHY configuration with changing PHY data rate by OFDM symbol addition, wherein further OFDM symbols are added at the end of the PPDU 58 after the OFDM symbols of the MPDU subframes using PHY changes. The inserted MPDU subframe with the PHY changes is thus not the last MPDU subframe in the PPDU 58. Finally, the above-described operation of legacy STA behavior may be performed.

Next, the non-PHY-adapting receiver STA operation is described for the sixth embodiment. Initially, the operation of step 501 is performed, i.e., regular operation is performed until training and signaling symbols are found. Then, the operation of step 502 is performed, i.e., PHY-change-info is obtained. After training and signaling symbols OFDM demodulation performed and the frequency de-mapping and/or constellation demapping are modified to apply PHY changes. Subsequently, the operation of step 503 (OFDM symbol synchronization and CW alignment) and PHY padding may be discarded or processed as explained above for Case 1 Mode 2. Then, the processing of step 504 is performed (continue processing of OFDM symbols if any). Finally, the above-described processing of a legacy STA may be performed.

Next, the PHY-adapting receiver STA operation is described for the sixth embodiment. Initially, the processing of step 601 (indication of whether a PPDU may contain PHY changes), step 602 (process OFDM symbols even if decoding fails) and step 603 (obtain PHY-change-info) is performed. The, OFDM symbols with PHY changes are processed. The last OFDM symbol preceding and/or containing PHY changes is performed and PHY padding if any is discarded or processed. Subsequently, as in step 306, the packet is forwarded to higher layers if received correctly. Finally, as in step 308 the processing of OFDM symbols is continued if more PHY changes are present.

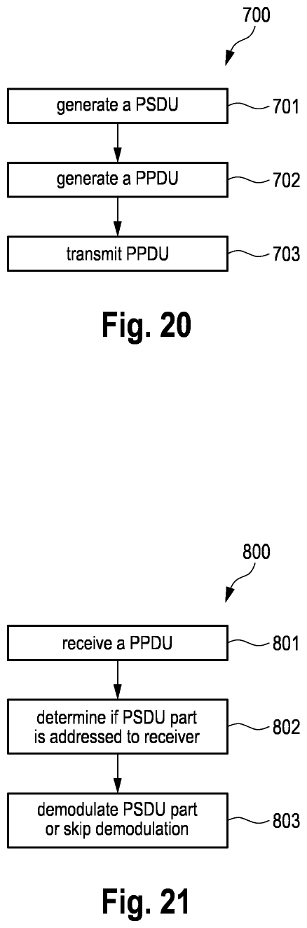

FIG. 20 shows a flow chart of another embodiment of a transmission method 700 according to the present disclosure. In a first step 701 a PSDU including at least two PSDU parts is generated. In a second step 702 a PPDU is generated from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols. In a third step 703 said PPDU is transmitted to at least two receiving devices.

FIG. 21 shows a flow chart of another embodiment of a receiving method 800 according to the present disclosure. In a first step 801 a PPDU carrying a PSDU including at least a first PSDU part and a second PSDU part is received. In a second step 802 it is determined if at least one PSDU part includes data addressed to the receiving device. In a third step 803 either said at least one PSDU part is demodulated or demodulation of said at least one PSDU part is skipped if it does not include data addressed to the receiving device or the receiving device is unable to perform demodulation according to the corresponding PHY operation that has been used for modulating said at least one PSDU part.

In summary, the preset disclosure focuses on link adaptation for transmitting A-MPDUs. The MPDUs aggregated in an A-MPDU may have different reliability or latency requirements. While they are conventionally transmitted with the same PHY configuration, the present disclosure presents mechanisms to support different PHY data rates for different MPDUs in an A-MPDU. The PHY changes are performed on an OFDM symbol basis and do not involve modifications to the channel coding operation.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject matter:
1. Transmission device comprising circuitry configured to:
   generate a physical layer (PHY) service data unit (PSDU) including at least two PSDU parts;
   generate a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and
   transmit said PPDU to at least two receiving devices.
2. Transmission device according to embodiment 1,
wherein the circuitry is configured to generate said PSDU from an aggregated media access control (MAC) protocol data unit (A-MPDU) including one or more first MAC protocol data units (MPDUs) and one or more second MPDUs, wherein the first PSDU part of said PSDU overlaps with or corresponds to one or more first MPDUs and the second PSDU part of said PSDU overlaps with or corresponds to one or more second MPDUs.
3. Transmission device according to embodiment 2,
wherein the one or more first MPDUs are addressed to a different receiving device than the one or more second MPDUs.
4. Transmission device according to embodiment 2 or 3,
wherein the circuitry is configured to select, as said one or more first MPDUs, priority MPDUs having higher reliability and/or lower latency requirements that said one or more second MPDUs.
5. Transmission device according to any one of preceding embodiments,
wherein the circuitry is configured to use at least one PHY operation for modulating said first PSDU part of said PSDU that is different than the PHY operations used for modulating the second PSDU part of said PSDU.
6. Transmission device according to any one of preceding embodiments,
wherein the circuitry is configured to apply, for using one or more of the following PHY operation changes for differently modulating said first PSDU part and/or said second PSDU part:
   enable or disable OFDM symbol replication,
   change OFDM symbol replication rate,
   change of modulation order,
   change of constellation mapping,
   change of tone mapping,
   enable or disable dual-carrier modulation,
   enable or disable space-time block coding, and
   change guard interval.
7. Transmission device according to any one of preceding embodiments,
wherein the circuitry is configured to apply, for modulating said first PSDU part, a more robust constellation and/or a different tone mapping.
8. Transmission device according to any one of preceding embodiments,
wherein the circuitry is configured to apply, for modulating said first PSDU part, OFDM symbol replication, wherein a different tone mapping is applied to each replicated first OFDM symbol corresponding to said first PSDU part.
9. Transmission device according to any one of preceding embodiments,
wherein the circuitry is configured to perform an initial session setup to exchange, with two or more receiver devices, information about respective capabilities and/or modes of PHY operation.
10. Transmission device according to embodiment 9,
wherein the circuitry is configured to use only modes of PHY operation that are supported by all receiving devices for the first and second PSDU part.
11. Transmission device according to embodiment 9 or 10,
wherein the circuitry is configured to exchange, as information about modes of PHY operation, one or more of:
   a session type identifier indicating a set of one or more PHY operations for use in modulating said first PSDU part,
   a signaling type identifier indicating how it is signaled which PSDU part is subjected to a different PHY operation, and
   a mode identifier indicating one or more PHY operations that can be used for modulating said first PSDU part.
12. Transmission device according to any one of preceding embodiments,
wherein the circuitry is configured to
   determine the PPDU length in case an indication to apply a different PHY operation to said first PSDU part has been obtained before a PPDU transmission start request has been issued and include PPDU length information indicating the determined PPDU length into the PPDU; or
   maintain the PPDU length of the PPDU in case an indication to apply a different PHY operation to said first PSDU part has been obtained after a PPDU transmission start request has been issued.
13. Transmission device according to embodiment 12,
wherein the circuitry is configured to determine if the time duration of the first number of OFDM symbols corresponding to the first PSDU part is smaller or larger than the PPDU length minus a margin accounting for the time duration of one or more of the second number of OFDM symbols and/or preamble duration and/or training fields duration and/or one or more additional training or signaling OFDM symbols included in the PPDU.
14. Transmission device according to any one of preceding embodiments,
wherein the circuitry is configured to signal PHY operation changes used for modulating the first PSDU part and/or second PSDU part to the at least two receiving devices in one of
   a preamble of the PPDU,
   a signaling field at the start of each PSDU part, and
   one or more additional training or signaling OFDM symbols included in the PPDU.
15. Transmission device according to any one of preceding embodiments,
wherein the circuitry is configured to encode each PSDU before subjecting it to modulation, wherein the code rate used for encoding the first PSDU part is identical to the code rate used for encoding the second PSDU part.
16. Transmission device according to any one of preceding embodiments,
wherein the circuitry is configured to apply one or more of aggregation, fragmentation and padding to said one or more first MPDUs and/or said one or more second MPDUs and/or to add padding to the A-MPDU to align the corresponding first and/or second PSDU parts to OFDM symbol borders.
17. Transmission device according to any one of preceding embodiments,
wherein the circuitry is configured to completely or partly remove the first and/or second PSDU parts if the time duration of the first number of OFDM symbols is larger than the PPDU length minus said margin.
18. Transmission device according to any one of preceding embodiments,
wherein the circuitry is configured to include the second PSDU part before the first PSDU part if the different PHY operation applied to the first PSDU part is not supported by the intended receiving device of the second PSDU part.
19. Receiving device comprising circuitry configured to:
   receive a physical layer (PHY) protocol data unit (PPDU) carrying a PSDU including at least a first PSDU part and a second PSDU part, wherein the first PSDU part has been modulated by a PHY operation that is different to the PHY operation used to modulate the second PSDU part;
   determine if at least one PSDU part includes data addressed to the receiving device; and
   either demodulate said at least one PSDU part or skip demodulation of said at least one PSDU part if it does not include data addressed to the receiving device or the receiving device is unable to perform demodulation according to the corresponding PHY operation that has been used for modulating said at least one PSDU part.
20. Receiving device according to embodiment 19,
wherein the circuitry is configured to
   derive an aggregated media access control (MAC) protocol data unit (A-MPDU) from a PSDU carried by a received PPDU, wherein said A-MPDU includes one or more first MAC protocol data units (MPDUs) and one or more second MPDUs and wherein the first PSDU part of the received PSDU overlaps with or corresponds to one or more first MPDUs and the second PSDU part of the received PSDU overlaps with or corresponds to one or more second MPDUs, and
   demodulate said first PSDU part if the first MPDUs are addressed to the receiving device and/or said second PSDU part if the second MPDUs are addressed to the receiving device.
21. Receiver device according to embodiment 19 or 20,
wherein the circuitry is configured to demodulate second and/or further PSDU parts if they include data addressed to the receiving device.
22. Receiving device according to any one of embodiments 19 to 21,
wherein the circuitry is configured to derive signaling of PHY operation changes indicating the modulation of the first PSDU part and/or second PSDU part by a transmission device from one of
   a preamble of the PPDU,
   a signaling field at the start of each PSDU part, and
   one or more additional training or signaling OFDM symbols included in the PPDU.
23. Receiving device according to any one of embodiments 19 to 22,
wherein the circuitry is configured to maintain OFDM symbol synchronization and/or codeword alignment if demodulation of said first PSDU part has been skipped.
24. Transmission method comprising:
   generating a physical layer (PHY) service data unit (PSDU) including at least two PSDU parts;
   generating a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and
   transmitting said PPDU to at least two receiving devices.
25. Receiving method comprising:
   receiving a physical layer (PHY) protocol data unit (PPDU) carrying a PSDU including at least a first PSDU part and a second PSDU part, wherein the first PSDU part has been modulated by a PHY operation that is different to the PHY operation used to modulate the second PSDU part;
   determining if at least one PSDU part includes data addressed to the receiving device; and
   either demodulating said at least one PSDU part or skipping demodulation of said at least one PSDU part if it does not include data addressed to the receiving device or the receiving device is unable to perform demodulation according to the corresponding PHY operation that has been used for modulating said at least one PSDU part.
26. A non-transitory computer-readable recording medium that stores therein a computer program product, which, when executed by a processor, causes the method according to embodiment 24 or 25 to be performed.
27. A computer program comprising program code means for causing a computer to perform the steps of said method according to embodiment 24 or 25 when said computer pro-gram is carried out on a computer.

1. Transmission device comprising circuitry configured to:
generate a physical layer (PHY) service data unit (PSDU) including at least two PSDU parts;
generate a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and
transmit said PPDU to at least two receiving devices.

2. Transmission device according to claim 1, wherein the circuitry is configured to generate said PSDU from an aggregated media access control (MAC) protocol data unit (A-MPDU) including one or more first MAC protocol data units (MPDUs) and one or more second MPDUs, wherein the first PSDU part of said PSDU overlaps with or corresponds to one or more first MPDUs and the second PSDU part of said PSDU overlaps with or corresponds to one or more second MPDUs, in particular wherein the one or more first MPDUs are addressed to a different receiving device than the one or more second MPDUs.

3. Transmission device according to claim 2, wherein the circuitry is configured to select, as said one or more first MPDUs, priority MPDUs having higher reliability and/or lower latency requirements that said one or more second MPDUs.

4. Transmission device according to claim 1, wherein the circuitry is configured to apply, for using one or more of the following PHY operation changes for differently modulating said first PSDU part and/or said second PSDU part:
enable or disable OFDM symbol replication,
change OFDM symbol replication rate,
change of modulation order,
change of constellation mapping,
change of tone mapping,
enable or disable dual-carrier modulation,
enable or disable space-time block coding, and
change guard interval.

5. Transmission device according to claim 1, wherein the circuitry is configured to apply, for modulating said first PSDU part, OFDM symbol replication, wherein a different tone mapping is applied to each replicated first OFDM symbol corresponding to said first PSDU part.

6. Transmission device according to claim 1, wherein the circuitry is configured to perform an initial session setup to exchange, with two or more receiver devices, information about respective capabilities and/or modes of PHY operation, in particular to use only modes of PHY operation that are supported by all receiving devices for the first and second PSDU part.

7. Transmission device according to claim 6, wherein the circuitry is configured to exchange, as information about modes of PHY operation, one or more of:
a session type identifier indicating a set of one or more PHY operations for use in modulating said first PSDU part,
a signaling type identifier indicating how it is signaled which PSDU part is subjected to a different PHY operation, and
a mode identifier indicating one or more PHY operations that can be used for modulating said first PSDU part.

8. Transmission device according to claim 1, wherein the circuitry is configured to
determine the PPDU length in case an indication to apply a different PHY operation to said first PSDU part has been obtained before a PPDU transmission start request has been issued and include PPDU length information indicating the determined PPDU length into the PPDU; or
maintain the PPDU length of the PPDU in case an indication to apply a different PHY operation to said first PSDU part has been obtained after a PPDU transmission start request has been issued.

9. Transmission device according to claim 8, wherein the circuitry is configured to determine if the time duration of the first number of OFDM symbols corresponding to the first PSDU part is smaller or larger than the PPDU length minus a margin accounting for the time duration of one or more of the second number of OFDM symbols and/or preamble duration and/or training fields duration and/or one or more additional training or signaling OFDM symbols included in the PPDU, and/or to completely or partly remove the first and/or second PSDU parts if the time duration of the first number of OFDM symbols is larger than the PPDU length minus said margin.

10. Transmission device according to claim 1,
wherein the circuitry is configured to signal PHY operation changes used for modulating the first PSDU part and/or second PSDU part to the at least two receiving devices in one of
a preamble of the PPDU,
a signaling field at the start of each PSDU part, and
one or more additional training or signaling OFDM symbols included in the PPDU.

11. Transmission device according to claim 1,
wherein the circuitry is configured to encode each PSDU before subjecting it to modulation, wherein the code rate used for encoding the first PSDU part is identical to the code rate used for encoding the second PSDU part.

12. Transmission device according to claim 1, wherein the circuitry is configured to apply one or more of aggregation, fragmentation and padding to said one or more first MPDUs and/or said one or more second MPDUs and/or to add padding to the A-MPDU to align the corresponding first and/or second PSDU parts to OFDM symbol borders.

13. Transmission device according to claim 1,
wherein the circuitry is configured to include the second PSDU part before the first PSDU part if the different PHY operation applied to the first PSDU part is not supported by the intended receiving device of the second PSDU part.

14. Receiving device comprising circuitry configured to:
receive a physical layer (PHY) protocol data unit (PPDU) carrying a PSDU including at least a first PSDU part and a second PSDU part, wherein the first PSDU part has been modulated by a PHY operation that is different to the PHY operation used to modulate the second PSDU part;
determine if at least one PSDU part includes data addressed to the receiving device; and
either demodulate said at least one PSDU part or skip demodulation of said at least one PSDU part if it does not include data addressed to the receiving device or the receiving device is unable to perform demodulation according to the corresponding PHY operation that has been used for modulating said at least one PSDU part.

15. Receiving device according to claim 14, wherein the circuitry is configured to
derive an aggregated media access control (MAC) protocol data unit (A-MPDU) from a PSDU carried by a received PPDU, wherein said A-MPDU includes one or more first MAC protocol data units (MPDUs) and one or more second MPDUs and wherein the first PSDU part of the received PSDU overlaps with or corresponds to one or more first MPDUs and the second PSDU part of the received PSDU overlaps with or corresponds to one or more second MPDUs, and
demodulate said first PSDU part if the first MPDUs are addressed to the receiving device and/or said second PSDU part if the second MPDUs are addressed to the receiving device.

16. Receiver device according to claim 14,
wherein the circuitry is configured to demodulate second and/or further PSDU parts if they include data addressed to the receiving device and/or to maintain OFDM symbol synchronization and/or codeword alignment if demodulation of said first PSDU part has been skipped.

17. Receiving device according to claim 14,
wherein the circuitry is configured to derive signaling of PHY operation changes indicating the modulation of the first PSDU part and/or second PSDU part by a transmission device from one of
a preamble of the PPDU,
a signaling field at the start of each PSDU part, and
one or more additional training or signaling OFDM symbols included in the PPDU.

18. Transmission method comprising:
generating a physical layer (PHY) service data unit (PSDU) including at least two PSDU parts;
generating a physical layer (PHY) protocol data unit (PPDU) from said PSDU including modulating the PSDU into a plurality of OFDM symbols included in the PPDU, wherein a first PSDU part of said PSDU corresponding to a first number of OFDM symbols is subjected to a different PHY operation than a second PSDU part of said PSDU corresponding to a second number of OFDM symbols; and
transmitting said PPDU to at least two receiving devices.

19. Receiving method comprising:
receiving a physical layer (PHY) protocol data unit (PPDU) carrying a PSDU including at least a first PSDU part and a second PSDU part, wherein the first PSDU part has been modulated by a PHY operation that is different to the PHY operation used to modulate the second PSDU part;
determining if at least one PSDU part includes data addressed to the receiving device; and
either demodulating said at least one PSDU part or skipping demodulation of said at least one PSDU part if it does not include data addressed to the receiving device or the receiving device is unable to perform demodulation according to the corresponding PHY operation that has been used for modulating said at least one PSDU part.

20. A non-transitory computer-readable recording medium that stores therein a computer program product, which, when executed by a processor, causes the method according to claim 18 to be performed.

21. A non-transitory computer-readable recording medium that stores therein a computer program product, which, when executed by a processor, causes the method according to claim 19 to be performed.
